(19) United States
(12) Patent Application Publication
(10) Pub. No.: US 2019/0012552 A1
(43) Pub. Date: Jan. 10, 2019

(54) HIDDEN DRIVER MONITORING

(71) Applicants: Yves Lambert, Van Buren Township, MI (US); Jean Luc Croy, Van Buren Township, MI (US); Benoit Chauveau, Van Buren Township, MI (US); Michel Cotty, Van Buren Township, MI (US); Remi Sigrist, Van Buren Township, MI (US)

(72) Inventors: Yves Lambert, Van Buren Township, MI (US); Jean Luc Croy, Van Buren Township, MI (US); Benoit Chauveau, Van Buren Township, MI (US); Michel Cotty, Van Buren Township, MI (US); Remi Sigrist, Van Buren Township, MI (US)

(21) Appl. No.: 15/642,854

(22) Filed: Jul. 6, 2017

(51) Int. Cl. G06K 9/00; H04N 5/33; G02B 27/01

(52) U.S. Cl. CPC G06K 9/00845; H04N 5/33; G06K 9/00255; G02B 2027/0138; G02B 27/0101; G06K 9/00604; G02B 2027/014; G06K 9/00261

(57) ABSTRACT

Disclosed herein are systems, methods, and devices for implementing a hidden driver monitoring. The aspects disclosed herein employ a camera, an infrared (IR) pulse generator, a circuit modified to work with the camera and the IR pulse generator. The aspects disclosed herein may be implemented as a standalone implementation, or with an existing head-up display (HUD) installed in the dashboard portion of a vehicle.

### BACKGROUND

Monitoring a driver of a vehicle during operation of the vehicle is becoming more common-place. In certain jurisdictions, for example Europe, this sort of monitoring may even lead to a vehicle being rated as more safe according to a metric provided for rating vehicle-based safety.

Driver monitoring systems have been implemented in where a camera is situated in the front portion of the vehicle, oriented at a direction towards the faces of the driver and/or occupants. The camera is configured to capture video/images of the drivers, and specifically the face, with image recognition techniques being employed to determine if the driver/occupants eyes are open, are focused on the road, or experiencing fatigue (for example, blinking at a greater rate).

However, implementing cameras in and around the vehicle-area is difficult. A camera is inherently a bulky object, and thus, may be unsightly or considered non-aesthetically pleasing. Thus, current systems for driver monitoring may include a provided for camera, with the camera being visible to the driver or occupant of the vehicle.

### SUMMARY

The following description relates to providing a system, method, and device for a driver monitoring system. Exemplary embodiments may also be directed to any of the system, the method, or an application disclosed herein, and the subsequent implementation in a vehicle.

The aspects disclosed herein include a system for monitoring driver awareness and gaze. The system includes a camera embedded in a dashboard of a vehicle, oriented towards a front window to the vehicle; an infrared (IR) pulse generator embedded in the dashboard of the vehicle; a driver monitoring circuit coupled to the camera and the IR pulse generator, and configured to: capture a first image via the camera; capture a second image via the camera, while simultaneously pulsing the IR pulse generator; and perform facial detection by subtracting elements of the first image from the second image.

In another embodiment, the system further includes a dichroic lens affixed to the camera.

In another embodiment, the system further includes a pulse generator configured to pulse IR light around 940 nanometers.

In another embodiment, the camera and the IR pulse generator are directly oriented at the front window.

In another embodiment, the system further includes a mirror.

In another, embodiment, the mirror is either flat or curved.

In another embodiment, the system includes a head-up display (HUD), wherein the camera and the IR pulse generator are embedded in the HUD.

In another embodiment, the HUD includes at least one backlight element, a thin film transistor TFT display, and a reflective surface, and the camera and the IR pulse generator are disposed in between the backlight element/TFT display and the reflective surface.

Additional features of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIG. 1 illustrates a first implementation of the aspects disclosed herein;

FIGS. 2(a) and (b) illustrate examples of the system and methods disclosed herein;

FIGS. 3(a)-(d) illustrate four embodiments of the system shown in FIG. 2(a);

FIG. 4 illustrates a second implementation of the aspects disclosed herein; and

FIGS. 5(a) and (b) illustrate the head-up display (HUD) according to the implementation shown in FIG. 4.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

As explained in the Background section, monitoring a driver allows vehicle-based systems to determine the state of the driver/occupant. In cases where the driver/occupant is detected with showing conditions of fatigue, various information may be generated or communicated. For example, various light and/or sound signals may be employed towards the driver forcing said driver into a state of awareness. Alternatively, other systems, such as autonomous driving systems may be initiated so as to automatically control the vehicle to drive in a safe manner, or alert a third-party responder.

However, as mentioned in the Background, and because space is limited, implementing said systems in a vehicle cockpit space may be difficult and unsightly. Thus, employing these systems while effectively hiding the componentry necessary to implement said systems is desired.

Disclosed herein are systems, methods, and devices for implementing a hidden driver monitoring. Thus, employing the aspects disclosed herein, cameras and other circuits of the driver monitoring system are effectively kept hidden, while still achieving the performance of said driver monitoring.

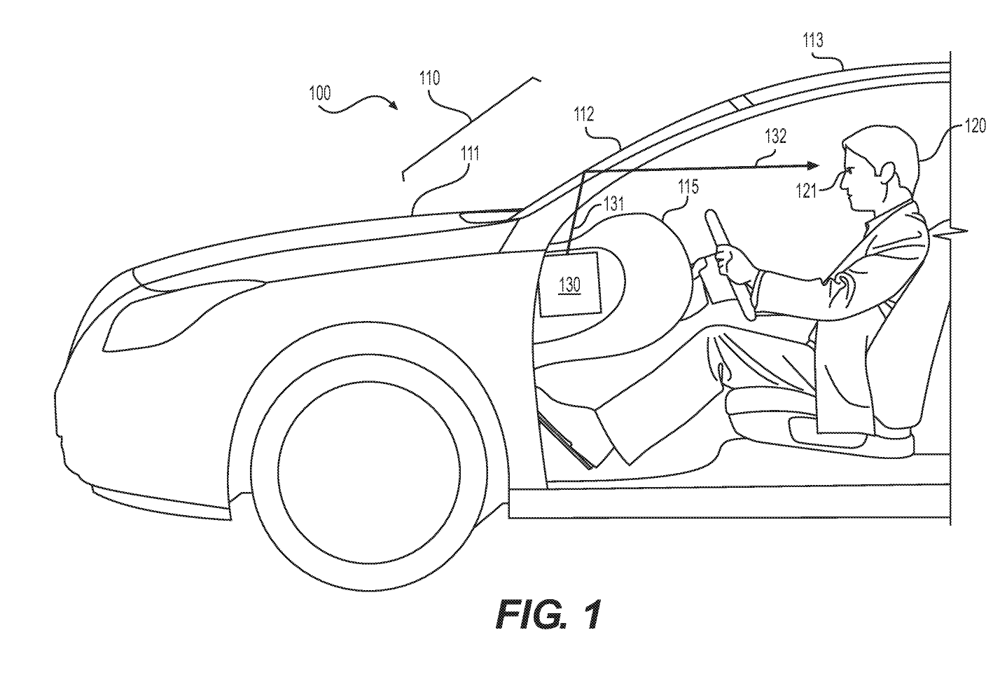

FIG. 1 illustrates an example implementation of the aspects disclosed herein. As shown in FIG. 1, an embedded/hidden driver monitoring system 130 is provided in a dashboard 114 of the vehicle 100. The vehicle 100 also includes a hood 111, a transparent front window 112, and a roof 113 (front 110 of the vehicle 100).

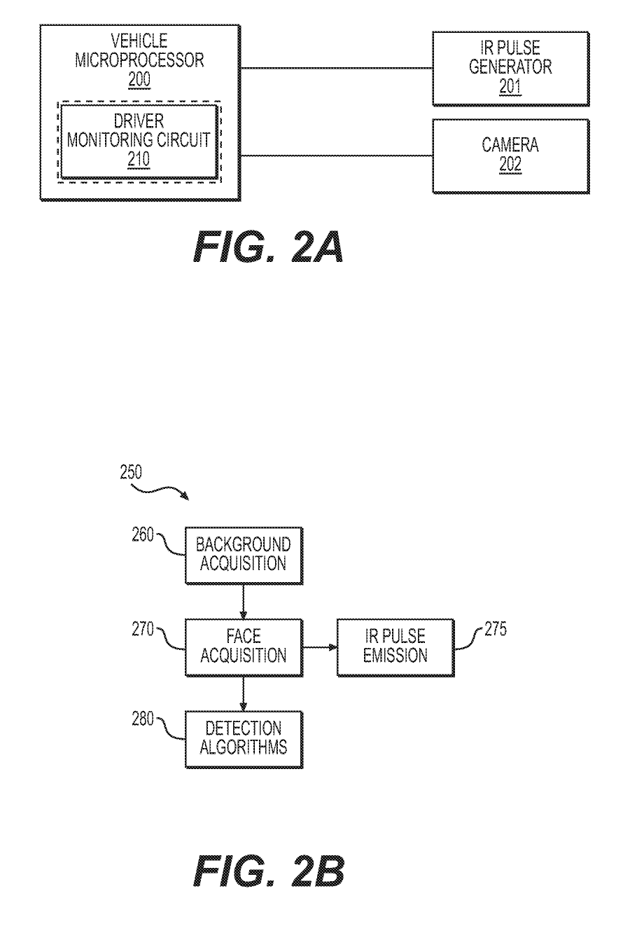

The operation of the system 130 will be described in greater detail in FIGS. 2(a) and (b). As shown in FIG. 1, a driver/occupant 120 is currently gazing out and in front of the vehicle 100 with eyes 120. The system 130, employing the optical path shown via 131 and 132 is capable of capturing said eyes 121 through the operations disclosed herein.

FIGS. 2(a) and (b) illustrate the operation of system 130 in greater detail. The vehicle microprocessor 200 may be any sort of central computer and/or processing system known in the art and commonly implemented in a vehicle-based electronic system. As shown, the vehicle microprocessor 200 includes a driver monitoring circuit 210. This driver monitoring circuit 210 may be implanted as part of the vehicle microprocessor 200 or provided as a standalone component.

Also shown in FIG. 2(a), are an infrared (IR) Pulse generator 201 and a camera 202. These components, and their specific operation will be described in greater detail below with the explanation of the method 250 shown in FIG. 2(b).

In operation 260, a first image is captured via the camera 202 oriented at pathway 131. In this way, an image substantially parallel to the driver/occupant 120 is captured including the sky and other background elements.

In operation 270, a second image is captured via the camera 202. Simultaneously or slightly before by a predetermined time, an IR pulse emission 275 is also produced via IR pulse generator 201. This ensures that an IR pulse is propagated off the front window 112 via pathway 131 towards pathway 132, and on to the driver/occupant's 120 eyes 121. The reflection of the eyes 121 is captured by the camera 202 in operation 270.

The camera 202 (or sensor) is synchronized with the IR pulse generator 201 so as to avoid the deleterious effects of sunlight. Through experimentation, the inventors have found that the wavelength of 940 nm is optimal for performing said task.

Further, the camera 202 is included with a dichroic filter. This is done to filter out light not compliant with a useful wavelength necessary to capture both the background image (in operation 260) and the facial image (in operation 270).

In operation 280, signal analysis is done by comparing the first image and the second image, and removing the sky portions of the first image, and receiving just the captured facial portions (i.e. the data reflected based on the IR pulse generator 201). In this way, subtracting the first image from the second image, allows a captured image of the face, and specifically the eyes 121 of driver/occupant 120.

Employing known signal/facial detection technologies, the system may then ascertain a state of the driver/occupant 120. As such, various stimuli and actions may be generated according to driver monitoring system technologies, such as those enumerated above.

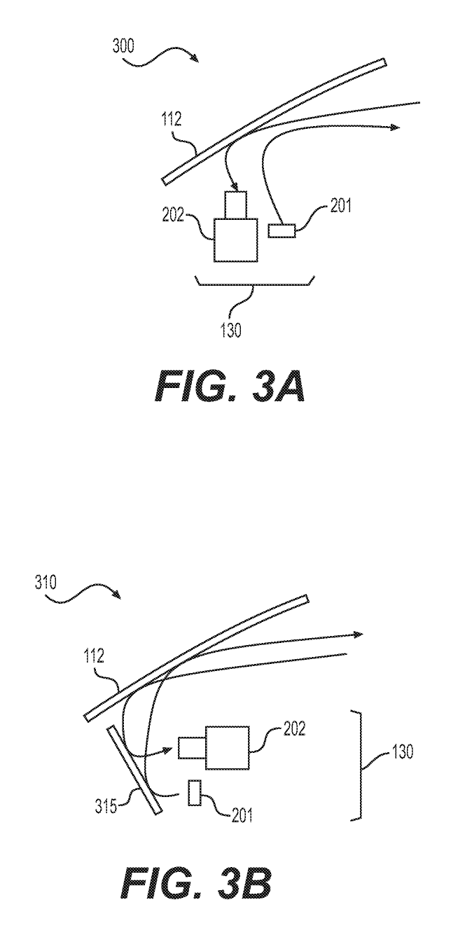

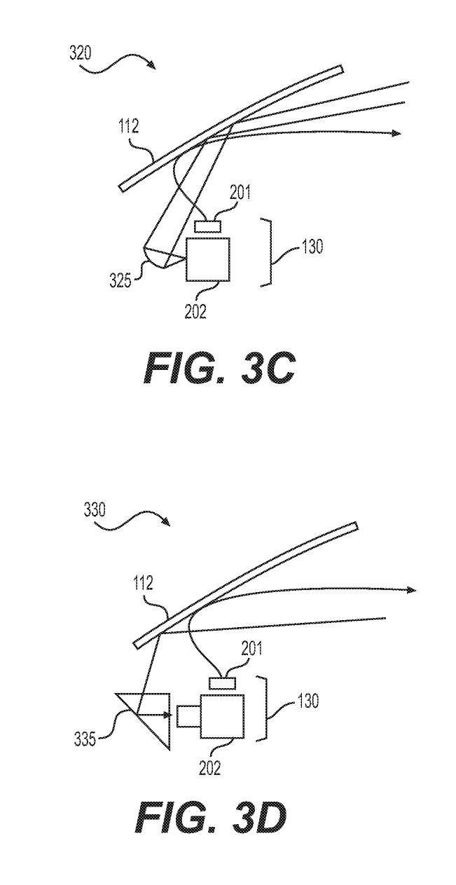

FIGS. 3(a)-(d) illustrate four different embodiments incorporating the aspects disclosed herein. In FIG. 3(a), embodiment 300 illustrates a camera 202 and a IR pulse generator 201 both configured to propagate a signal directly off the front window 112 towards the driver 120 (not shown).

In FIG. 3(b), embodiment 310 illustrates another embodiment of the aspects disclosed herein. Instead of propagating a signal directly off the front window 112, a reflective flat mirror 315 is provided as intermediary element prior to reflecting a signal(s) off the front window 112.

In FIG. 3(c), embodiment 320 illustrates a third embodiment of the aspects disclosed herein. As shown, instead of a flat mirror 315, a curved mirror 325 is provided. In FIG. 3(d), embodiment 330 illustrates a fourth embodiment of the aspects disclosed herein. As shown, a prism 335 is provided to guide light to and from the camera 202.

In all the embodiments shown, the system 130 is embedded in a dashboard area 115 of the vehicle 100.

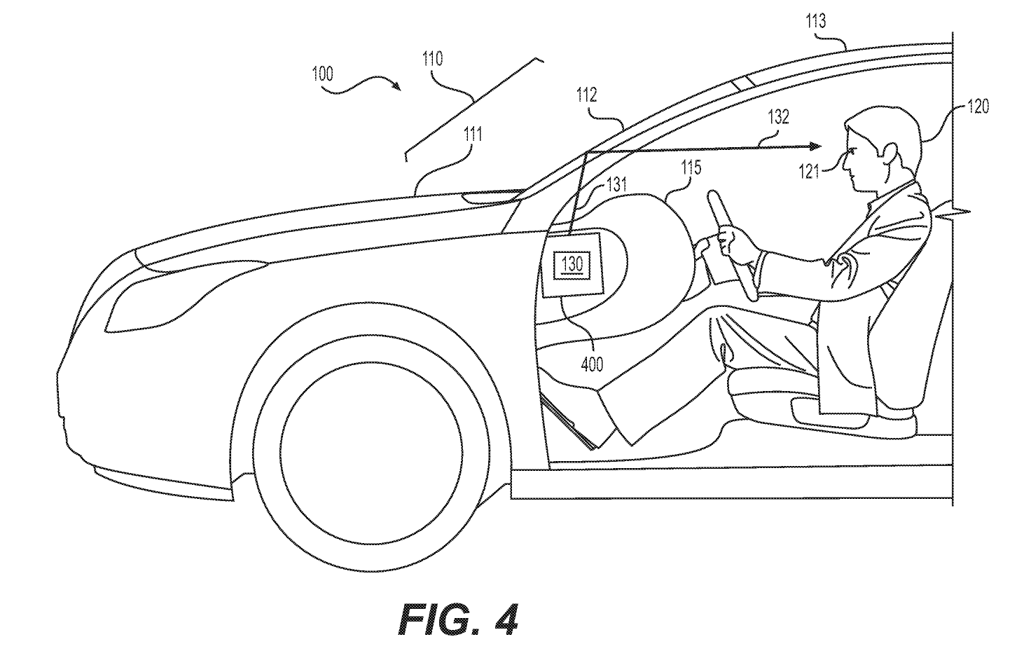

FIG. 4 illustrates a second implementation employing the concepts disclosed herein. As shown in FIG. 4, everything is substantially similar to FIG. 1, except head-up display (HUD) 400 is provided.

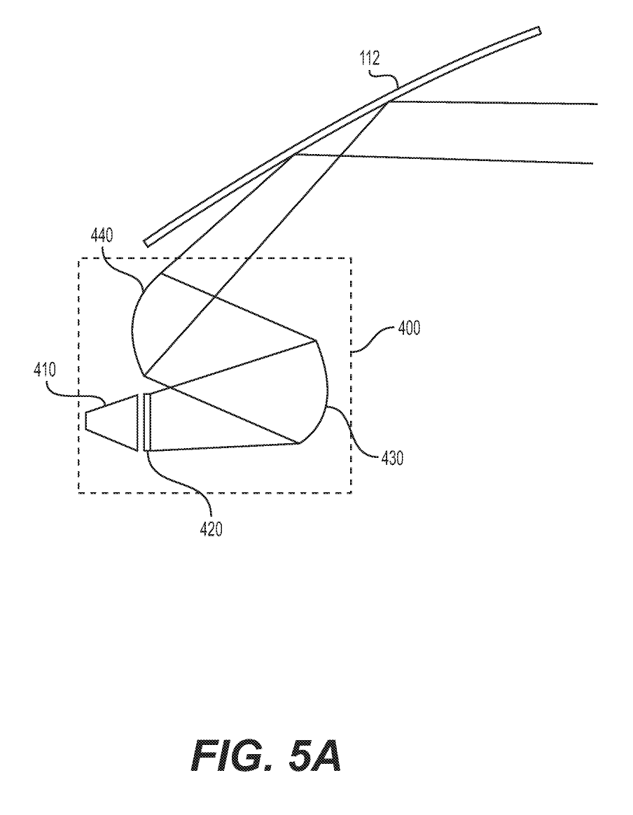

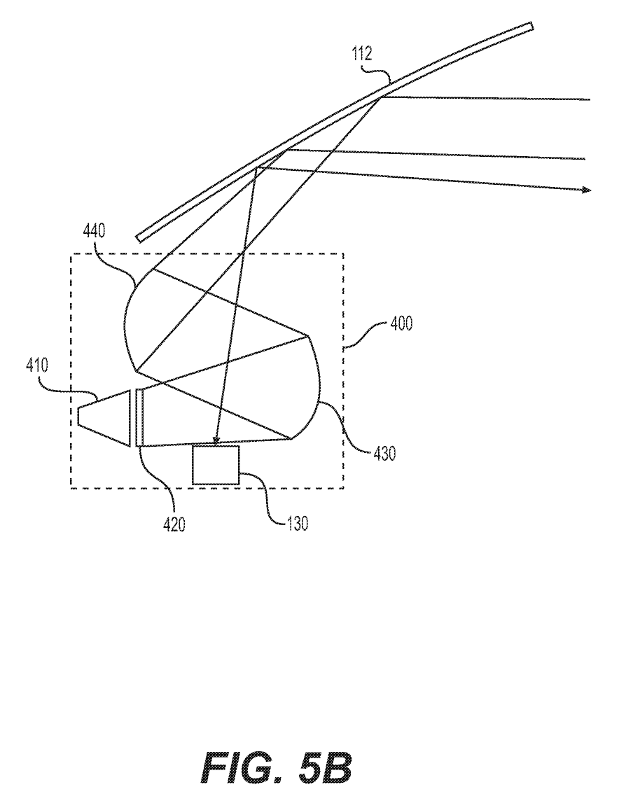

FIG. 5(a) illustrates the HUD 400 without system 130, while FIG. 5(b) illustrates HUD 400 with system 130. In both views, the HUD 400 includes a backlight 410 which illuminates a thin film transistor display 420 by propagating light off a first mirror 430 and a second mirror 440. Thus, content is reflected off a front window 112 and presented to the eyes 121 (or commonly referred to in HUD terminology as “eyebox”) of the viewer 120.

Employing the aspects disclosed herein, the area reserved for a HUD 400 implementation, may also include system 130 embedded in an area between the backlight 410/TFT display 420 and the first mirror 430. Thus, as shown in the previous figures, the system 130 may employ the aspects disclosed herein.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

We claim:

1. A system for monitoring driver awareness and gaze, comprising:
a camera embedded in a dashboard of a vehicle, oriented towards a front window to the vehicle;
an infrared (IR) pulse generator embedded in the dashboard of the vehicle;
a driver monitoring circuit coupled to the camera and the IR pulse generator, and configured to:
capture a first image via the camera;
capture a second image via the camera, while simultaneously pulsing the IR pulse generator; and
perform facial detection by subtracting elements of the first image from the second image.

2. The system according to claim 1, further comprising a dichroic lens affixed to the camera.

3. The system according to claim 1, wherein the IR pulse generator is configured to pulse IR light around 940 nanometers.

4. The system according to claim 1, wherein the camera and the IR pulse generator are directly oriented at the front window.

5. The system according to claim 1, further comprising a mirror, wherein the camera and the IR pulse generator are oriented at the mirror.

6. The system according to claim 5, wherein the mirror is a flat mirror.

7. The system according to claim 5, wherein the mirror is a curved mirror.

8. The system according to claim 1, further comprising a prism, wherein the camera and the IR pulse generator are oriented at the prism.

9. The system according to claim 1, further comprising a head-up display (HUD), wherein the camera and the IR pulse generator are embedded in the HUD.

10. The system according to claim 9, wherein the HUD includes at least one backlight element, a thin film transistor TFT display, and a reflective surface, and the camera and the IR pulse generator are disposed in between the backlight element/TFT display and the reflective surface.
